(19) United States
(12) Patent Application Publication
(10) Pub. No.: US 2026/0030864 A1
(43) Pub. Date: Jan. 29, 2026

(54) System and Method for Saliency-Adaptive Snapshot Compressive Imaging

(71) Applicant: The University of Hong Kong, Hong Kong (HK)

(72) Inventors: Yaping ZHAO, Hong Kong (HK); Edmund Yin Mun LAM, Hong Kong (HK)

(21) Appl. No.: 18/783,371

(22) Filed: Jul. 24, 2024

(51) Int. Cl. G06V 10/46

(52) U.S. Cl. CPC G06V 10/462

(57) ABSTRACT

The present invention provides a self-adaptive and saliency-aware snapshot compressive imaging (SCI) system. In comparison with the existing SCI systems, the self-adaptive and saliency-aware SCI system of the present invention integrates saliency detection, which feedbacks to the coding masks with a calculated sampling efficiency for updating the coding masks. As such, self-adaptation of the system is achieved, and high-level information such as saliency is also obtained and given consideration, thereby producing reconstruction results with better quality, lower power cost and higher efficiency.

### FIELD OF THE INVENTION

The present invention relates to the field of imaging systems. More specifically, the present invention presents an improved snapshot compressive imaging system by adopting saliency detection and self-adaptive sensing matrices.

### BACKGROUND

In view of the extensive data for accurate capturing and reconstruction of dynamic scenes of required by traditional imaging systems, snapshot compressive imaging (SCI) systems have been developed as an improved alternative.

The Nyquist-Shannon sampling theorem, essential principle regarding the sample rate required to avoid signal distortion known as aliasing, states that if a function x(t) contains no frequencies higher than B Hz, then it can be completely determined from its ordinates at a sequence of points spaced less than 1/(2B) seconds apart, meaning that reconstruction without any aliasing is guaranteed for a bandlimit B<fₛ/2. It is, however, made possible through the SCI systems, through leveraging the principles of compressive sensing, to reconstruct signals and images with far fewer samples typically required by the Nyquist-Shannon sampling theorem, which in turn reduces the need for high-bandwidth data transfer and storage capacity, and lower costs for sensors and acquisition systems.

Additionally, SCI systems are capable of efficiently capturing high-dimensional (HD) data due to the advent of novel optical designs to sample the HD data as two-dimensional (2D) compressed measurements, therefore enabling the systems to acquire HD visual signals in single snapshots, as opposed to conventional methods. This feature allows SCI systems to offer promising solutions for real-world applications across various fields, including but not limited to surveillance, biomedical imaging and remote sensing.

Nonetheless, the traditional SCI scheme is fundamentally limited, due to the complete disregard for high-level information in the sampling process. This is due to the development of the SCI system predominantly focusing on the restruction algorithms and less on the compression sampling methods and optimization of coding mask designs.

Further, current sampling methods employ random binary masks equally to all pixels, thereby disregarding all high-level information such as objects and saliency. As such, consideration of respective importance of different regions of the image is lacking.

The general “sampling-reconstruction-tasks” scheme of traditional SCI is fundamentally limited, as not only does it lead to wasteful resource allocation for content-irrelevant computation due to the complete ignorance of high-level information in the sampling process, but also that the sampling and design efficiency is hampered due to the independence between each computer vision.

Therefore, there is a need for an improved SCI system which addresses the issues of both the complete disregard of high-level information which leads to lowered computation efficiency and wasteful resource allocation, and low sampling efficiency due to the independence between computer visions. The present invention addresses this need.

### SUMMARY OF THE INVENTION

The present invention provides a saliency-aware and self-adaptive snapshot compressive imaging system, designed to address the aforementioned limitations faced by traditional SCI systems, namely the disregard of high-level information and independence between computer visions.

In an aspect of the present invention, the saliency-aware and self-adaptive snapshot compressive imaging system comprises a modulating device including coding masks, a dynamic image detector and an image reconstruction data processor. As the modulating device presents the coding masks to the dynamic scene to be detected, the dynamic scene which is projected to the coding masks is captured by the dynamic image detector and received by the image reconstruction data processor as the first measurement. The first measurement is then subjected to saliency detection to obtain saliency maps, based on which the sampling probability is calculated. The sampling probability is then used to update the coding masks of the modulating device for the compression, image reconstruction of a subsequent frame of the captured dynamic scene, and subsequent self-adaptation of the coding masks.

In one embodiment, the coding masks of the saliency-aware and self-adaptive snapshot compressive imaging system comprise first sensing matrices generated by randomly sampling elements from a Bernoulli distribution with probability p=0.5.

In another embodiment, the coding masks of the saliency-aware and self-adaptive snapshot compressive imaging system is updated with the sampling probability through assigning higher sampling probabilities to image regions with higher salient events according to saliency maps, assigning lower sampling probabilities to image regions with lower salient events according to saliency maps, and assigning a fixed probability to image regions without salient events according to saliency maps.

In other aspect, the average peak signal-to-noise ratio of the reconstruction results is increased by 0.2 to 0.5 dB compared to the reconstruction results of a snapshot compressive imaging system without saliency-aware and self-adaptive features.

In yet another aspect, the average structural similarity index of the reconstruction results is increased by 0.01 to 0.03 compared to the reconstruction results of a snapshot compressive imaging system without saliency-aware and self-adaptive features.

In yet other aspect, the average processing speed of the dynamic scene by the saliency-aware and self-adaptive snapshot compressive imaging system of the present invention is below 300 fps.

In another aspect of the present invention, the saliency-aware and self-adaptive snapshot compressive imaging system comprises a modulating device including coding masks, a dynamic image detector and an image reconstruction data processor. As the modulating device presents the coding masks to the dynamic scene to be detected, the dynamic scene which is projected to the coding masks is captured by the dynamic image detector and received by the image reconstruction data processor as the first measurement. The first measurement is subjected to a reconstruction algorithm to obtain reconstructed images. The reconstructed images are then subjected to saliency detection to obtain saliency maps, based on which the sampling probability is calculated. The sampling probability is then used to update the coding masks of the modulating device for the compression, image reconstruction of a subsequent frame of the captured dynamic scene, and subsequent self-adaptation of the coding masks.

In one embodiment, the coding masks of the saliency-aware and self-adaptive snapshot compressive imaging system comprise first sensing matrices generated by randomly sampling elements from a Bernoulli distribution with probability p=0.5.

In another embodiment, the coding masks of the saliency-aware and self-adaptive snapshot compressive imaging system is updated with the sampling probability through assigning higher sampling probabilities to image regions with higher salient events according to saliency maps, assigning lower sampling probabilities to image regions with lower salient events according to saliency maps, and assigning a fixed probability to image regions without salient events according to saliency maps.

In other aspect, the average peak signal-to-noise ratio of the reconstruction results is increased by 0.2 to 0.5 dB compared to the reconstruction results of a snapshot compressive imaging system without saliency-aware and self-adaptive features.

In yet another aspect, the average structural similarity index of the reconstruction results is increased by 0.01 to 0.03 compared to the reconstruction results of a snapshot compressive imaging system without saliency-aware and self-adaptive features.

In yet other aspect, the average processing speed of the dynamic scene by the saliency-aware and self-adaptive snapshot compressive imaging system of the present invention is below 300 fps.

### BRIEF DESCRIPTION OF DRAWINGS

Embodiments of the invention are described in more details hereinafter with reference to the drawings, in which:

FIG. 1 shows the comparison between the different stages of reconstruction under the traditional snapshot compressive imaging (SCI) framework and the SCI framework with saliency detection to perform self-adaptive sampling in the present invention.

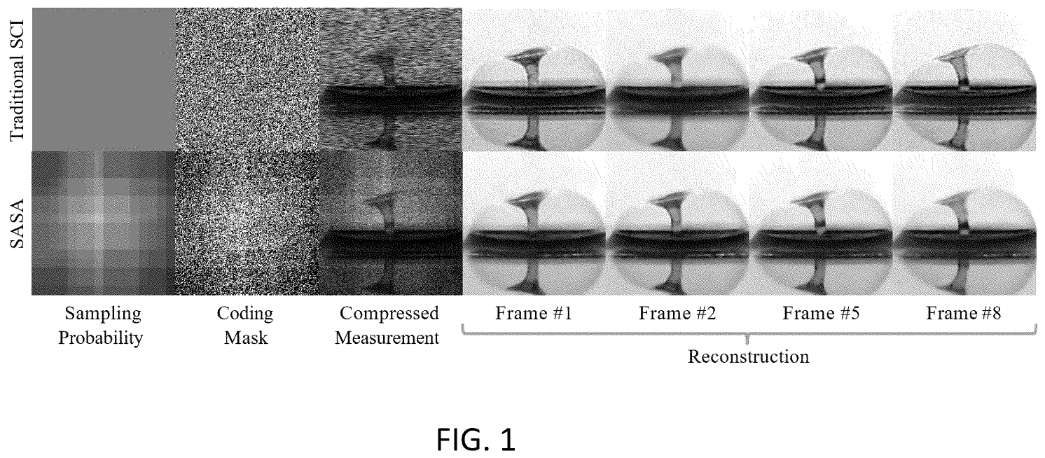

FIG. 2 provides comparative schematics of the pipeline of traditional SCI system and the saliency-aware self-adaptive SCI of the present invention.

FIG. 3 shows the comparisons of reconstruction results on the datasets Kobe and Vehicle respectively. Reconstruction is conducted with the reconstruction algorithm ADMM-TV.

FIG. 4 shows further comparisons of reconstruction results on the dataset Vehicle. Reconstruction is conducted with the reconstruction algorithm DEQSCI.

FIG. 5 provides a schematic diagram of the SCI system of the present invention, comprising a modulating device 10 including coding masks, dynamic image detector 20 and data processor 30, with all three components interconnected to each other.

### DETAILED DESCRIPTION

Provided herewith is a framework integrating saliency detection into snapshot compressive imaging (SCI) system, which enable the performing of self-adaptive sampling, thereby boosting the quality of compressed measurement and the performance of reconstruction result.

The key principle behind SCI lies in the compression of the acquired HD data. In short, in a typical SCI system, a modulating device, for example a coding mask, is used to apply a known sensing matrix to the dynamic scene, which the scene projected onto the coded matrix is converted into a compressed representation, to be subsequently captured by a detector. The captured compressed representation will be subjected to reconstruction algorithms to reconstruct high-dimensional data, for example high-resolution image, hyperspectral data or a 3D scene.

As explained above, this technology requires far fewer samples typically required by the Nyquist-Shannon sampling theorem, thereby also enabling high-speed imaging, resource efficiency and cost reduction.

However, the lack of compression sampling method and coding mask optimization, coupled with the disregard of high-level information and independence of each individual image, results in rooms of improvement yet to be addressed in the efficiency of sampling and effectiveness of the design.

Therefore, the present invention addresses these issues by incorporating saliency detection to the compressed representations in the SCI system and, based on the resulting saliency maps, the coding masks are adaptively adjusted and updated with the sampling probabilities, thereby allowing subsequent compressions to be performed with saliency taken into consideration and each subsequent compression updated by the sampling parameters of the previous compression.

Saliency detection aims to identify the more important and/or prominent parts of an image or video through features including but not limited color, texture or motion, in an attempt to mimic human perception and visual information processing by highlighting areas that attract human attention more than others.

The saliency detection process fundamentally involves two steps. First, various features of the target image sequence or video, for example color and orientation, are extracted. The extracted features are then combined and converted into a grayscale representation known as saliency maps, in which different regions are assigned different values corresponding to their respective saliency, i.e. the degree in which these regions are deemed effective in attracting human attention. The saliency maps could be further refined and post-processed with additional techniques such as thresholding for better highlighting.

In the present invention particularly, the captured compressed measurements, in addition to subjecting to reconstruction process, are also subjected to saliency detection. The saliency maps thus retrieved are then used for the calculation of sampling probability for the next video sequence, with higher sampling probability assigned to the regions of higher saliency, lower sampling probability assigned to the regions of lower saliency, and assigning a background sampling probability to regions with no saliency to ensure sampling coverage. These parameters are updated to the coding masks for the subsequent image sequence or video sequence to be compressed, thereby enabling self-adaptation and establishing dependency between each subsequent sequences.

Alternatively, saliency detection can be conducted to the images reconstructed by a reconstruction algorithm through which the compressed measurements are subjected, and the retrieval of saliency maps are used for the calculation of sampling probability for the next video sequency to demonstrate self-adaptation. This dual approach allows optimization of computational resource management through flexibility in the application of saliency detection, and thereby increasing speed and reduces computational costs.

Accordingly, through incorporating the saliency detection mechanism, the SCI system of the present invention is able to take into account saliency, which other existing SCI systems generally disregard. In addition, the saliency detection and sampling probabilities are used to update the coding masks for subsequent image or video sequence compression, thereby optimizing the coding masks with self-adaptation and greatly enhances the sampling efficiency through streamlining the sampling process with minimal atomic operation and processing speed required.

The SCI system of the present invention improves the efficiency and would only require a few atomic operations, making the SCI system highly suitable for real-time applications while having a low requirement to the processing speed on the data processor, requiring an average 250 fps. The SCI system of the present invention therefore provides a low-cost and low-power consumption alternative.

The present invention relates to a saliency-aware and self-adaptive snapshot compressive imaging system designed to optimize image compression and reconstruction dynamically. This system integrates a modulating device equipped with coding masks, a dynamic image detector, and a data processor. The data processor is programmed to execute image reconstruction and self-adaptive sampling.

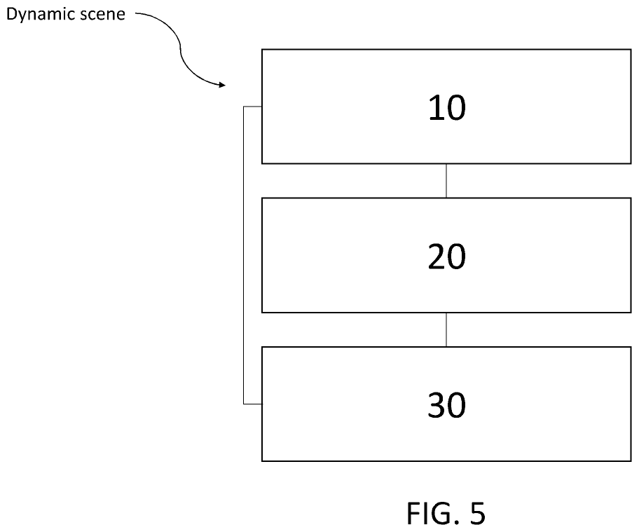

Referring to FIG. 5, the SCI system of the present invention is a tri-component system, comprising a modulating device with coding masks that modulate the incoming light from the dynamic scene, and are crucial in the initial compression of the image data.

The second component is a dynamic image detector, which captures the modulated light from the dynamic scene, converting it into a compressed measurement signal.

The third component is the data processor, which is central to the system's functionality, handling image reconstruction and self-adaptive sampling.

The data processor performs the following steps:
Receives the first compressed measurement signal, which is obtained by projecting the dynamic scene onto the modulating device and capturing it with the dynamic image detector.
Applies a reconstruction algorithm to the first compressed measurement signal to perform image reconstruction and saliency detection, producing saliency maps.
Calculates a sampling probability based on the saliency maps.
Updates the coding masks of the modulating device using the calculated sampling probability, optimizing the compression of subsequent frames of the dynamic scene.

To illustrate in more details, the data processor subjects the initial compressed measurement signal to a sophisticated reconstruction algorithm that not only reconstructs the image but also identifies salient regions within the scene. The saliency maps generated through this process highlight areas of the image with significant changes or features. Using these saliency maps, the data processor calculates sampling probabilities, which determine how the coding masks will be updated. This adaptive updating process ensures that regions with higher saliency receive more sampling attention, enhancing the overall image quality in these areas, while regions with lower saliency or no salient events receive proportionally less attention or a fixed probability.

The coding masks in the modulating device are initially configured using first sensing matrices. These matrices are generated by randomly sampling elements from a Bernoulli distribution with a probability of p=0.5. This stochastic approach ensures a robust and diverse sampling pattern for the initial frame.

Once the saliency maps are obtained through the data processing, higher sampling probabilities are assigned to image regions identified with higher salient events according to the saliency maps. Similarly, lower sampling probabilities are assigned to regions with lower salient events; and a fixed sampling probability is maintained for regions without any salient events, ensuring that the entire scene is still represented in the compressed measurement signal.

The sampling probabilities are then utilized to update the coding masks in the modulating device, such that the subsequent sampling is performed on a weighted basis.

By adopting the system of the present invention, significant improvements are demonstrated in its image reconstruction metrics compared to non-saliency-aware and non-self-adaptive systems, including an average increase of peak signal-to-noise ratio by 0.2 to 0.5 dB, and an average increase of structural similarity index (SSIM) by 0.01 to 0.03.

In addition, The data processor is capable of processing the dynamic scene at an average speed below 300 frames per second (fps), ensuring real-time or near-real-time performance.

In summary, the saliency-aware and self-adaptive snapshot compressive imaging system leverages dynamic modulation, adaptive sampling, and sophisticated reconstruction algorithms to enhance image quality and processing efficiency, making it a powerful tool for various imaging applications.

### Example

### Example 1—Method

The present invention provides a novel formulation of the sampling process in video SCI, and an efficient and effective algorithm for the generation of adaptive coding masks in a low-cost and low-power fashion.

Table 1 below outlines the notations used in further discussions.

TABLE 1

| Notation | Description |
|---|---|
| X ϵ [symbol] | The video frames we aim to compress and reconstruct. |
| | ∀_{c} = 1, . . ., C, X, = X(:, :, c) ϵ [symbol] is the c-th video frame. |
| | Here, H, W and C are the image height, image width and compression rate, respectively. |
| E ϵ [symbol] | The measurement noise. |
| Y ϵ [symbol] | The compressed measurement. |
| A ϵ {0, 1}^{H × W × C} | The sensing matrix we use to compress the video frames. |
| | ∀h = 1, . . ., H, ∀w = 1, . . ., W, ∀c = 1, . . ., C, A_{c} = A(:, :, c) ϵ {0, 1}^{H × W} is the c-th |
| | coding mask, |
| | [symbol] _{hwc} = A(h, w, c) ϵ {0, 1} is the element on the h-th row and w-th column of the c-th coding mask. |
| Bernoulli(p) | The Bernoulli distribution, which is the discrete probability distribution of a random variable which |
| | takes the value 1 with probability p and the value 0 with probability q = 1 − p. |
| S ϵ [symbol] | The saliency maps, where S_{d} = S(:, :, d) ϵ {0, 1}^{H ×} ^{W}, is the d-th saliency map. |
| | Here, value 1 indicates saliency, and value 0 indicates no saliency. |
| | D is the maximum number of detections to examine. |
| P ϵ [symbol] | The sampling probability, where p_{hw} = P(h, w) ϵ [0, 1] is a probability parameter. |

[symbol]

indicates data missing or illegible when filed

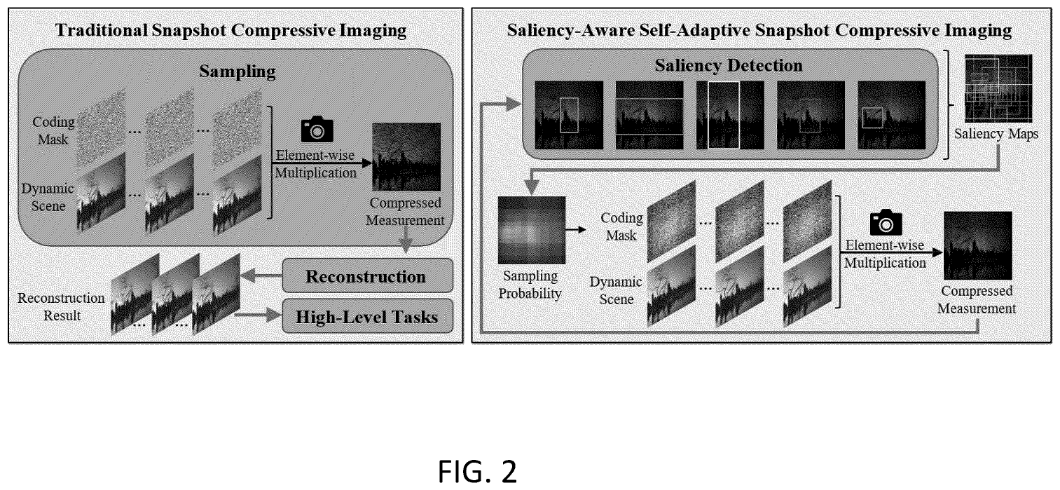

Taking reference from FIG. 2, in comparison with the traditional SCI pipeline which generates random binary matrices as coding mass to obtain compressed measurements, the saliency detection is utilized in the SCI framework of the present invention to perform self-adaptive sampling.

The acquisition of compressed measurements in the video SCI system of the present invention is mathematically modeled as below:

$$Y = {{\sum }^{C}}_{c = 1} {A}_{c} ⊙ {X}_{c} + E , \qquad ( 1 )$$

where Y is the compressed measurement, A is the sensing matrix, X is the video frames we aim to compress and reconstruct, E is the measurement noise, and ⊙ denotes the Hadamard (element-wise) product.

In traditional SCI, the sensing matrix A is always generated by randomly sampling elements from a Bernoulli distribution with probability p=0.5. The first sensing matrix of the SCI system of the present invention is initialized by the traditional method as below:

$${A}^{( 0 )} = [ {a}_{hwc}^{( 0 )} ] , {a}_{hwc}^{( 0 )} ∼ Bernoulli ( 0.5 ) , \qquad ( 2 )$$

$$∀ h = 1 , … , H , ∀ w = 1 , … , W , ∀ c = 1 , … , C ,$$

which is used for preliminary compression of the dynamic scene.

Accordingly, the first measurement as below is obtained and captured from the preliminary compression:

$${Y}^{( 0 )} = {{\sum }^{C}}_{c = 1} {A}_{c}^{( 0 )} ⊙ {X}_{c}^{( 0 )} + {E}^{( 0 )} . \qquad ( 3 )$$

Once the first measurement is obtained, advanced vision processing technology, i.e. saliency detection, is performed directly on the measurement instead of on the reconstructed video, to boost inference speed and reduce bandwidth occupation, memory footprint and energy consumption. Specifically, a light-weight algorithm is adopted and denoted herein as f, which takes the measurement Y^{(t)} corresponding to the t-th video sequence as input and outputs saliency maps S^{(t)}:

$${S}^{( t )} = f ( {Y}^{( t )} ; D ) , t = 0 , 1 , 2 , … , \qquad ( 4 )$$

where D is a parameter that determines the maximum number of detections to examine.

Based on the estimated saliency maps, we calculate the sampling probability for the next video sequence by retrieving saliency in the compressed domain with low bandwidth:

$${P}^{( t + 1 )} = \frac{1}{D} {\sum }_{d = 1}^{D} {S}_{d}^{( t )} , t = 0 , 1 , 2 , … , \qquad ( 5 )$$

where P is the sampling probability used to guide sensing matrix generation for the next video sequence.

Higher sampling probabilities are assigned to salient image regions and lower are to non-salient, ensuring an adaptive and effective sampling process. To ensure sampling coverage in regions without salient events, a probability of 1/D is then assigned to areas with zero probability.

According to P=[p_{hw}], the sensing matrix is updated by:

$${A}^{( t + 1 )} = [ {a}_{hwc}^{( t + 1 )} ] , {a}_{hwc}^{( t + 1 )} ∼ Bernoulli ( {p}_{hw}^{( t + 1 )} ) , \qquad ( 6 )$$

$$∀ h = 1 , … , H , ∀ w = 1 , … , W , ∀ c = 1 , … , C ,$$

$$t = 0 , 1 , 2 , … .$$

The sampling of acquiring compressed measurements should be performed adaptively, which assigns a higher sampling probability to salient image regions and lower to non-salient regions.

Finally, the measurement of the next video sequence is captured using the dynamically updated sensing matrix:

$${Y}^{( t + 1 )} = {{\sum }^{C}}_{c = 1} {A}_{c}^{( t + 1 )} ⊙ {X}_{c}^{( t + 1 )} + {E}^{( t + 1 )} , \qquad ( 7 )$$

$$t = 0 , 1 , 2 , … .$$

The method of the present invention, which performs saliency detection directly on the measurement, requires only a few atomic operations to generate sensing matrices.

In adopting the above method of the present invention, the processing speed is on average 250 fps on a single laptop CPU. In the other words, it enables a low-speed camera to capture high-speed scenes with C×250 fps while intelligently and adaptively varying the coding masks.

### Example 2—Setting and Evaluation

### 2.1 Setting

The first sensing matrix and compressed measurement are initialized following the traditional SCI, and the method as described above is adopted to generate adaptive sensing matrices for capturing sequential compressed measurements.

For evaluations, four of the six classical SCI datasets, including “Aerial”, “Vehicle”, “Kobe” and “Traffic” are adopted, while the remaining two (“Drop” and “Runner”) are excluded because the videos are too short and contain only one single measurement.

Two classical SCI reconstruction algorithms ADMM-TV and GAP-TV, and a state-of-the-art method DEQSCI are conducted on different measurements compressed and captured by traditional SCI and the SCI framework of the present invention respectively, for the reconstruction of videos.

### 2.2 Quantitative and Qualitative Evaluations

Quantitative comparison results of different compressed measurements are provided in Table 2 below.

TABLE 2
(Results in terms of PSNR (dB) and SSIM by different compressed measurements on four classical
datasets):

| Dataset | Aerial | Vehicle | Kobe | Traffic | Average |
|---|---|---|---|---|---|
| Recon. | ADMM-TV | | | | |
| Trad. SCI | 24.54, 0.877 | 23.88, 0.822 | 25.38, 0.821 | 20.15, 0.740 | 23.49, 0.815 |
| SASA | 24.61, 0.882 | 24.44, 0.862 | 26.35, 0.877 | 20.19, 0.746 | 23.90, 0.842 |
| Recon. | GAP-TV | | | | |
| Trad. SCI | 24.69, 0.861 | 24.51, 0.867 | 25.97, 0.863 | 20.44, 0.763 | 23.90, 0.839 |
| SASA | 24.71, 0.864 | 24.57, 0.872 | 26.80, 0.895 | 20.48, 0.771 | 24.13, 0.851 |

It is observed that the present method achieve an approximate 0.2 to 0.5 dB improvement in peak signal-to-noise ratio (PSNR), and 0.01 to 0.03 improvement in structural similarity index (SSIM) on average.

The improvement indicates that the present system is capable of reconstructing images with relative fine structure, which is confirmed by qualitative evaluations.

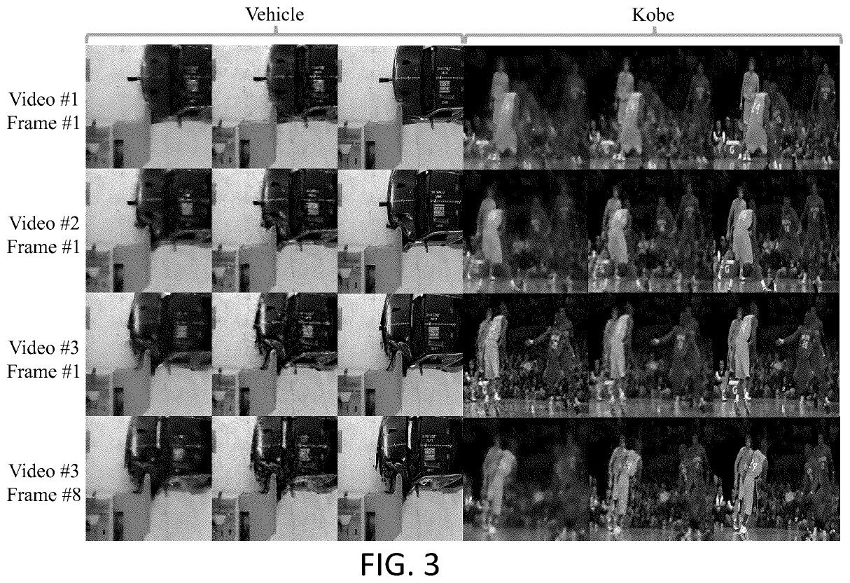

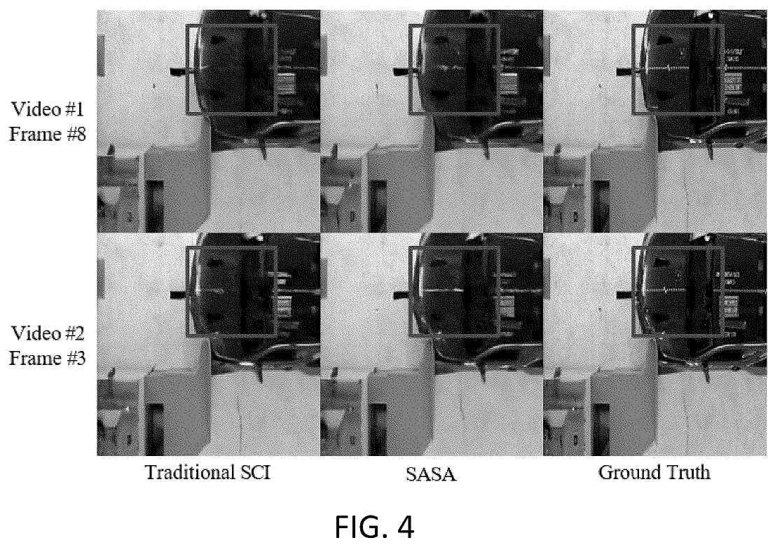

Referring to FIGS. 3 and 4, reconstruction results from traditional SCI have more artifacts and distortions around margins; while the present method maintains a clear and accurate image structure in the reconstruction results, leading to higher performance.

The present method adjusts coding masks adaptively during the sampling process, which displays highly consistent integration with existing reconstruction algorithms and enhances performances across all baselines.

Additionally, the reconstruction quality can be further improved using various video processing techniques including specific denoising, video colorization improvement, etc.

### 2.3 Ablation Study

An ablation study on different maximum detection numbers in saliency detection is performed, using GAP-TV as the choice of reconstruction algorithm,

The results are tabulated in Table 3 below.

TABLE 3
(Ablation study on different maximum detection
numbers in saliency detection)

| D | Aerial | Vehicle | Kobe | Traffic | Average |
|---|---|---|---|---|---|
| 10 | 24.77, 0.871 | 23.69, 0.867 | 25.16, 0.845 | 19.92, 0.740 | 23.39, 0.831 |
| 20 | 24.55, 0.859 | 24.13, 0.856 | 25.89, 0.857 | 20.39, 0.759 | 23.74, 0.833 |
| 30 | 24.71, 0.864 | 24.57, 0.871 | 26.80, 0.895 | 20.48, 0.770 | 24.13, 0.850 |
| 40 | 24.56, 0.865 | 24.53, 0.873 | 26.62, 0.896 | 20.26, 0.754 | 23.99, 0.847 |
| 50 | 24.42, 0.862 | 24.41, 0.871 | 26.48, 0.896 | 20.16, 0.745 | 23.87, 0.843 |

As is observed in the results above, D=30 is found to be the best setting to achieve the best reconstruction results, both in terms of PSNR and SSIM.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A saliency-aware and self-adaptive snapshot compressive imaging system comprising:
a modulating device including coding masks;
a dynamic image detector; and
a data processor;
wherein the data processor perform image reconstruction and self-adaptive sampling, comprising:
receiving a first compressed measurement signal obtained by projecting a dynamic scene to the modulating device and capturing by the dynamic image detector;
subjecting the first compressed measurement signal to a reconstruction algorithm for image reconstruction and saliency detection to obtain saliency maps;
calculating a sampling probability based on the saliency maps; and
updating the coding masks of the modulating device with the sampling probability for the compression of a subsequent frame of the captured dynamic scene.

2. The saliency-aware and self-adaptive snapshot compressive imaging system of claim 1, wherein the coding masks comprise first sensing matrices generated by randomly sampling elements from a Bernoulli distribution with probability p=0.5.

3. The saliency-aware and self-adaptive snapshot compressive imaging system of claim 1, wherein the updating the coding masks with the sampling probability comprises:
assigning higher sampling probabilities to image regions with higher salient events according to the saliency maps;
assigning lower sampling probabilities to image regions with lower salient events according to the saliency maps; and
assigning a fixed probability to image regions without salient events according to the saliency maps.

4. The saliency-aware and self-adaptive snapshot compressive imaging system of claim 1, wherein the average peak signal-to-noise ratio of the reconstruction results is increased by 0.2 to 0.5 dB compared to reconstruction results of a non-saliency-aware and non-self-adaptive snapshot compressive imaging system.

5. The saliency-aware and self-adaptive snapshot compressive imaging system of claim 1, wherein the average structural similarity index of the reconstruction results is increased by 0.01 to 0.03 compared to reconstruction results of a non-saliency-aware and non-self-adaptive snapshot compressive imaging system.

6. The saliency-aware and self-adaptive snapshot compressive imaging system of claim 1, wherein the average processing speed of the dynamic scene by the data processor is below 300 fps.

7. A saliency-aware and self-adaptive snapshot compressive imaging system comprising:
a modulating device including coding masks;
a dynamic image detector; and
a data processor;
wherein the data processor perform image reconstruction and self-adaptive sampling, comprising:
receiving a first compressed measurement signal obtained by projecting a dynamic scene to the modulating device and capturing by the dynamic image detector;
subjecting the first compressed measurement signal to a reconstruction algorithm for image reconstruction;
subjecting the reconstructed image to saliency detection to obtain saliency maps;
calculating a sampling probability based on the saliency maps; and
updating the coding masks of the modulating device with the sampling probability for the compression of a subsequent frame of the captured dynamic scene.

8. The saliency-aware and self-adaptive snapshot compressive imaging system of claim 7, wherein the coding masks comprise first sensing matrices generated by randomly sampling elements from a Bernoulli distribution with probability p=0.5.

9. The saliency-aware and self-adaptive snapshot compressive imaging system of claim 7, wherein the updating the coding masks with the sampling probability comprises:
assigning higher sampling probabilities to image regions with higher salient events according to the saliency maps;
assigning lower sampling probabilities to image regions with lower salient events according to the saliency maps; and
assigning a fixed probability to image regions without salient events according to the saliency maps.

10. The saliency-aware and self-adaptive snapshot compressive imaging system of claim 7, wherein the average peak signal-to-noise ratio of the reconstruction results is increased by 0.2 to 0.5 dB compared to reconstruction results of a non-saliency-aware and non-self-adaptive snapshot compressive imaging system.

11. The saliency-aware and self-adaptive snapshot compressive imaging system of claim 7, wherein the average structural similarity index of the reconstruction results is increased by 0.01 to 0.03 compared to reconstruction results of a non-saliency-aware and non-self-adaptive snapshot compressive imaging system.

12. The saliency-aware and self-adaptive snapshot compressive imaging system of claim 7, wherein the average processing speed of the dynamic scene by the data processor is below 300 fps.
